(19) United States
(12) Patent Application Publication
(10) Pub. No.: US 2023/0308520 A1
(43) Pub. Date: Sep. 28, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Naoki SHIBUYA, Kanagawa (JP)

(73) Assignee: FUJIFILM Business Innovation Corp., Tokyo (JP)

(21) Appl. No.: 17/889,045

(22) Filed: Aug. 16, 2022

(30) Foreign Application Priority Data
Mar. 25, 2022 (JP) 2022-049656

(51) Int. Cl. H04L 67/54; H04L 51/043; H04L 67/50

(52) U.S. Cl. CPC H04L 67/54; H04L 51/043; H04L 67/535

(57) ABSTRACT

An information processing apparatus includes a processor configured to: identify, for an event that occurs in association with an instruction for executing a process given by a user using a messenger application, the event occurring at a place other than a location of the user, a responder who is present at the place of occurrence of the event and who is able to respond to the event, with reference to schedule information of possible responders and history information of conversations made by the possible responders using the messenger application; and make a request to the responder to respond to the event, by using the messenger application.

### Cross-Reference to Related Applications

This application is based on and claims priority under 35 USC 119 from Japanese Patent Application No. 2022-049656 filed Mar. 25, 2022.

### BACKGROUND

### (i) Technical Field

The present disclosure relates to an information processing apparatus, a non-transitory computer readable medium, and an information processing method.

### (ii) Related Art

“Chat” has been used as an application tool for exchanging messages in real time by using computers. In recent years, dedicated services called “business chat” have been launched and increasingly employed by companies as intra-company communication tools in place of email.

Recently, devices installed in an office have been sometimes used from outside the office by using business chat. For example, with business chat, a document can be transmitted to a customer from home by using a facsimile function of a multifunction machine installed in an office.

However, the user is unable to respond, by themselves, to an error that has occurred during use of the device in the office from outside the office. Therefore, the user wants to request someone in the office to respond to the occurring error.

In the related art, a technique has been proposed in which beacons or a GPS of user terminals carried by users are used to identify and manage the locations of the users, thereby enabling identification of users present in the office (for example, Japanese Unexamined Patent Application Publication Nos. 2019-161303 and 2016-212720).

### SUMMARY

In the related art, however, to identify the locations of possible responders who are candidates to whom the user wants to make a request to respond to an event that has occurred at a place other than the location of the user, the possible responders individually need to carry terminals, and capital investment needs to be made as appropriate.

Even when a possible responder who is present at the place where the event has occurred can be identified and the user makes a request to the possible responder to respond to the event, the possible responder who receives the request might not actually respond. Therefore, a search for a person who can actually respond may take effort. Specifically, in the related art, even in an environment in which a messenger application is available, history information of conversations made by using the messenger application is not referred to in a search for a responder to the event.

Aspects of non-limiting embodiments of the present disclosure relate to allowing a request to a person who can respond to an occurring event to be made with more certainty than in a case where history information of conversations made by using a messenger application is not referred to.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: identify, for an event that occurs in association with an instruction for executing a process given by a user using a messenger application, the event occurring at a place other than a location of the user, a responder who is present at the place of occurrence of the event and who is able to respond to the event, with reference to schedule information of possible responders and history information of conversations made by the possible responders using the messenger application; and make a request to the responder to respond to the event, by using the messenger application.

### BRIEF DESCRIPTION OF THE DRAWINGS

Exemplary embodiments of the present disclosure will be described in detail based on the following figures, wherein:

FIG. 1 is a diagram illustrating an overall configuration of a network system including a chat system according to Exemplary Embodiment 1;

FIG. 2 is a diagram for explaining an overall process flow in Exemplary Embodiment 1;

FIG. 3 is a flowchart illustrating a responder identification process in Exemplary Embodiment 1; and

FIG. 4 is a diagram illustrating an overall configuration of a network system according to Exemplary Embodiment 4.

### DETAILED DESCRIPTION

Hereinafter, exemplary embodiments of the present disclosure will be described with reference to the drawings.

### Exemplary Embodiment 1

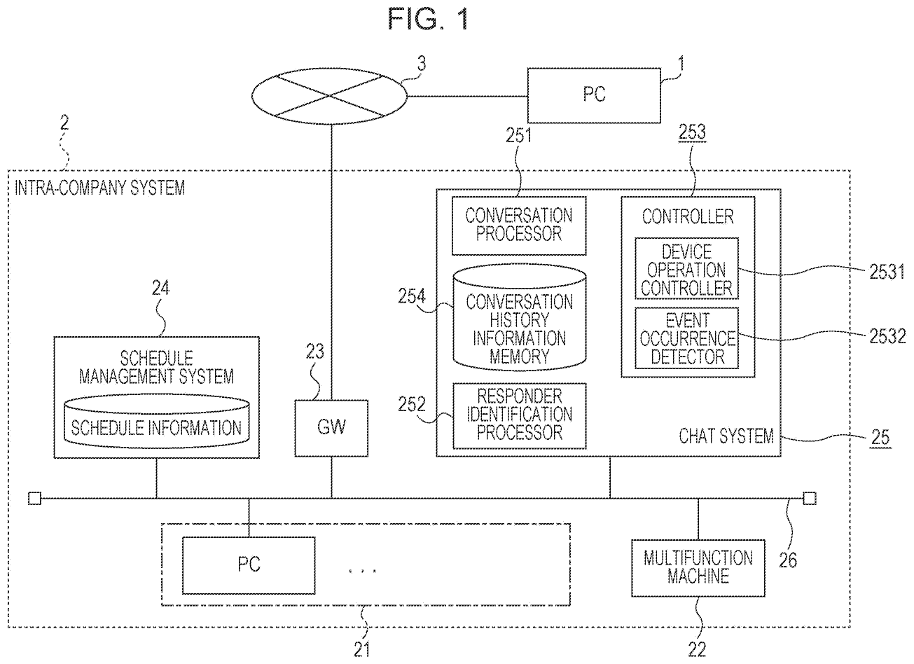

FIG. 1 is a diagram illustrating an overall configuration of a network system including a chat system according to this exemplary embodiment. FIG. 1 illustrates a configuration in which a personal computer (PC) 1 and an intra-company system 2 are connected to each other via a network 3 that includes the Internet.

The intra-company system 2 is a local area network (LAN) system that is built in an office of a certain company, and the PC 1 is an information processing apparatus that is used by, for example, an employee (hereinafter referred to as “user”) of the company who uses the intra-company system 2 from outside the office. The PC 1 can be implemented with an existing general-purpose hardware configuration. That is, the PC 1 includes a central processing unit (CPU), a read-only memory (ROM), a random access memory (RAM), a storage such as a hard disk drive (HDD), a network interface that functions as a communication unit, and a user interface that includes input units such as a mouse and a keyboard and a display unit such as a display. A chat application is installed in the PC 1 to exchange messages with PCs 21 used by other users via a chat room provided by a chat system 25.

“Chat” is defined as, for example, a system for real-time conversations over the Internet, and the chat system 25 provides a chat service to a user who uses a computer in which the chat application for enabling chat is installed.

“Messenger application” is a general term for applications that provide a messaging function of, for example, exchanging text messages and exchanging messages by, for example, free IP calls. In this exemplary embodiment, although a description of an example case where the chat application is used as this messenger application to provide the messaging function to users will be given, for example, other messenger applications that provide the messaging function may be used.

The intra-company system 2 is a LAN system built in the company as described above. The intra-company system 2 includes the PCs 21, a multifunction machine 22, a gateway (GW) 23, a schedule management system 24, and the chat system 25, which are connected to a LAN 26. The PCs 21, the multifunction machine 22, the gateway 23, the schedule management system 24, and the chat system 25 can communicate with each other via the LAN 26. Note that FIG. 1 illustrates only configurations that are referred to in descriptions, and the other configurations are omitted.

The PCs 21 are information processing apparatuses that are used in the office by users. The PCs 21 need to have a hardware configuration similar to that of the PC 1. The PC 21 that is taken out of the office can function as the PC 1. In contrast, the PC 1 that is connected to the LAN 26 can function as the PC 21. Note that the PC 1 and the PC 21 are collectively referred to as “PC” without a reference numeral when these PCs need not be distinguished from each other.

The multifunction machine 22 is an example of a device that is used by users. The multifunction machine 22 is an example of an image forming apparatus, and is an apparatus that implements a print function, a copy function, a scanner function, a facsimile function, and other various functions and that includes a computer. The multifunction machine 22 includes a computer, and therefore, includes a ROM, a RAM, an HDD, a network interface, and an operation panel that functions as a user interface and further includes a printer and a scanner to provide various functions. The multifunction machine 22 in this exemplary embodiment can be used from outside the office via the gateway 23.

The gateway 23 relays, via the network 3, data that is exchanged between the intra-company system 2 and an external device via the network 3. The PC 1 is an example of the external device.

The schedule management system 24 is an information processing apparatus that performs schedule management of users. The schedule management system 24 in this exemplary embodiment can be implemented with an existing general-purpose hardware configuration of, for example, a server computer. That is, the schedule management system 24 includes at least a CPU, a ROM, a RAM, a storage such as an HDD, and a network interface. Although schedule management performed by the schedule management system 24 may be implemented with software developed in house, a schedule management function provided by a commercially available product, such as Outlook (registered trademark), for work scheduling, personal scheduling management, and so on may be used.

The chat system 25 provides the chat service to the user of a PC in which the chat application is installed as described above. The chat system 25 is an example of an information processing apparatus according to exemplary embodiments of the present disclosure and can be implemented with an existing general-purpose hardware configuration of, for example, a server computer. That is, the chat system 25 includes at least a CPU, a ROM, a RAM, a storage such as an HDD, and a network interface. Although the chat system 25 may be installed outside the office, the chat system 25 is included in the intra-company system 2 in this exemplary embodiment by taking into consideration convenience of the use of schedule information managed by the schedule management system 24.

The chat system 25 includes a conversation processor 251, a responder identification processor 252, a controller 253, and a conversation history information memory 254. Note that configuration elements not referred to in the description of this exemplary embodiment are omitted from FIG. 1.

The conversation processor 251 performs a process related to exchanges of messages performed by the users of PCs posting messages to the chat room, that is, conversations. The conversation processor 251 saves posted messages in the conversation history information memory 254 as conversation history information. More specifically, the conversation processor 251 obtains a message posted to a Web page (“chat room” described above) that is provided by the chat system 25 as a place for exchanging messages in a specific group, and accumulates conversation history information that includes the content of the obtained message in the conversation history information memory 254. The conversation history information includes at least the posting date and time of the message, the poster, the posted content (that is, the message), and identification information of the chat room to which the message is posted.

The responder identification processor 252 identifies a user who responds to an event that occurs during use of the multifunction machine 22 from outside the office, as a responder to the event.

The controller 253 operates in cooperation with the conversation processor 251 and the responder identification processor 252 described above to thereby control conversations made in the chat system 25. The controller 253 includes a device operation controller 2531 and an event occurrence detector 2532. When the content of a message posted by using chat is an instruction for executing a process, the device operation controller 2531 instructs a device concerned to execute the process and receives the result of execution of the process executed by the device in response to the instruction. The event occurrence detector 2532 constantly monitors conversations made by using the chat room and detects a predetermined event from the content or posting state of a message. In this exemplary embodiment, as an example of the detection target event, an error that occurs during use of the multifunction machine 22 by a user from outside the office will be described.

The conversation processor 251, the responder identification processor 252, and the controller 253 in the chat system 25 are implemented by cooperative operations between the computer that forms the chat system 25 and a program that runs on the CPU included in the computer. The conversation history information memory 254 is implemented as the HDD included in the chat system 25. Alternatively, the RAM may be used or an external memory may be used via a network.

Programs used in this exemplary embodiment can be provided via a communication unit as a matter of course or can be stored in a computer-readable recording medium, such as a compact disc read-only memory (CD-ROM) or a Universal Serial Bus (USB) memory, and provided. The programs provided via a communication unit or a recording medium are installed in a computer and sequentially executed by the CPU of the computer to thereby execute various processes.

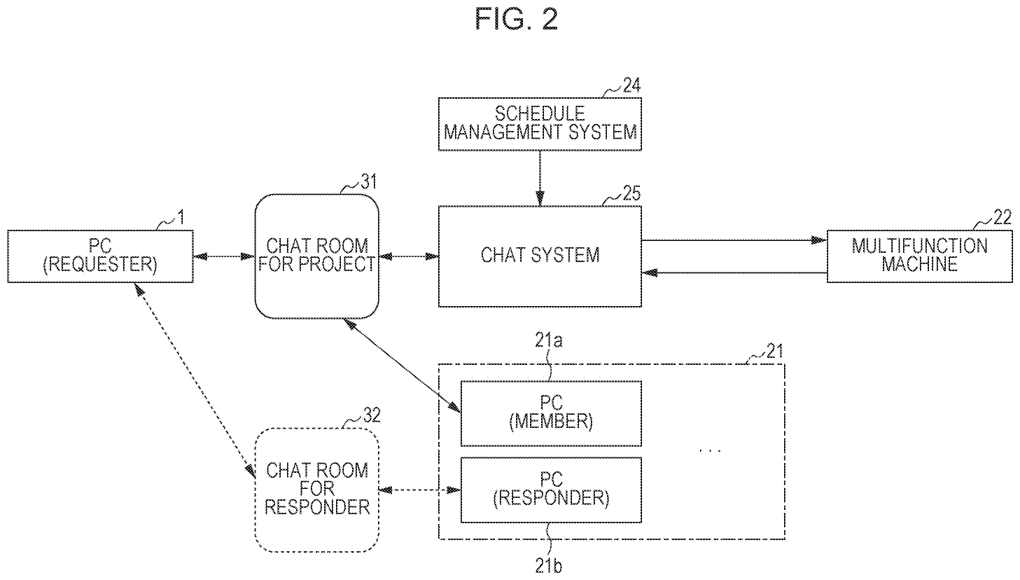

FIG. 2 is a diagram for explaining an overall process flow in this exemplary embodiment and illustrates some of the configuration elements in the network system illustrated in FIG. 1. Corresponding configuration elements in FIG. 1 and FIG. 2 are assigned the same reference numerals. First, the overall process flow in this exemplary embodiment will be described with reference to FIG. 1 and FIG. 2.

Currently, business chat that is provided by the chat system 25 as a tool for exchanging messages is not only for exchanging messages between users but also for allowing a device to execute a process in response to an instruction from a user for executing the process. In this exemplary embodiment, the multifunction machine 22 is assumed to be an example of the device, and a description will be given.

Members of a project team including a user outside the office exchange messages via a chat room 31 that is generated exclusively for the project team as illustrated in FIG. 2. The user outside the office can instruct the multifunction machine 22 from the PC 1 to execute a facsimile transmission process. Specifically, the user specifies a transmission target document and posts to the chat room 31 a message for instructing the multifunction machine 22 to perform facsimile transmission. The conversation processor 251 saves the posted message in the conversation history information memory 254. The conversation processor 251 also functions as a chat bot and interprets the content of the posted message by performing natural language processing. When the conversation processor 251 determines that the message corresponds to an instruction for executing a process, the device operation controller 2531 transmits to the multifunction machine 22 data of the transmission target document, the address, and other information to be used in facsimile transmission to thereby instruct the multifunction machine 22 to perform facsimile transmission. The device operation controller 2531 receives the result of execution of the facsimile transmission process from the multifunction machine 22. The result of execution indicates successful completion or abnormal termination and, in a case of abnormal termination, includes information with which the occurring error can be identified. The conversation processor 251 posts a message about the result of execution obtained by the device operation controller 2531 to the chat room 31 to thereby give a notification to the user of the PC 1 who has requested the process.

Although the user of the PC 1 who is outside the office gives an instruction for executing a process via the chat room 31 for the project team to which the user belongs, the user may use, for example, a personal chat room generated for the user of the PC 1.

There is no problem when use of a device installed in the office from outside the office as described above is successfully completed; however, there may be a case where a quick response is to be made to an error, if any. “Error” described here is not limited to a case where the result of execution indicates abnormal termination and includes a case where no response is made to an instruction for execution, that is, the result of execution is not received. “Quick” approximately means quicker than in a case where the user who recognizes the occurrence of the error comes to the office to respond to the error. In such a case, the user wants someone in the office to respond to the error. However, it is not always the case that anyone in the office is an appropriate person. A user in the office can be a possible responder who can respond to the error; however, in actuality, a case where a possible responder has a schedule and, for example, is participating in a meeting is easily imagined.

In this exemplary embodiment, when the user of the PC 1 is present at a place, that is, a place outside the office in this example, and an error has occurred at a place other than the place outside the office, that is, inside the office, a user (which is referred to as “responder” in this exemplary embodiment) who can respond to the error among users (which are referred to as “possible responders” in this exemplary embodiment) in the office is identified with reference to the schedule information and the conversation history information of the possible responders. The conversation history information as well as the schedule information is referred to because possible responders may use chat to make conversations about a schedule not reflected in the schedule information. Examples of the schedule not reflected in the schedule information include a schedule that is to be managed by the schedule management system 24 but is not yet registered in the schedule information and a schedule that is managed by the schedule management system 24 but is canceled or changed. A change in a schedule includes not only a change in the date and time but also a change in the place and a change in the target persons (for example, participants in a meeting). Accordingly, in this exemplary embodiment, the schedules of users can be grasped more accurately with reference to the conversation history information.

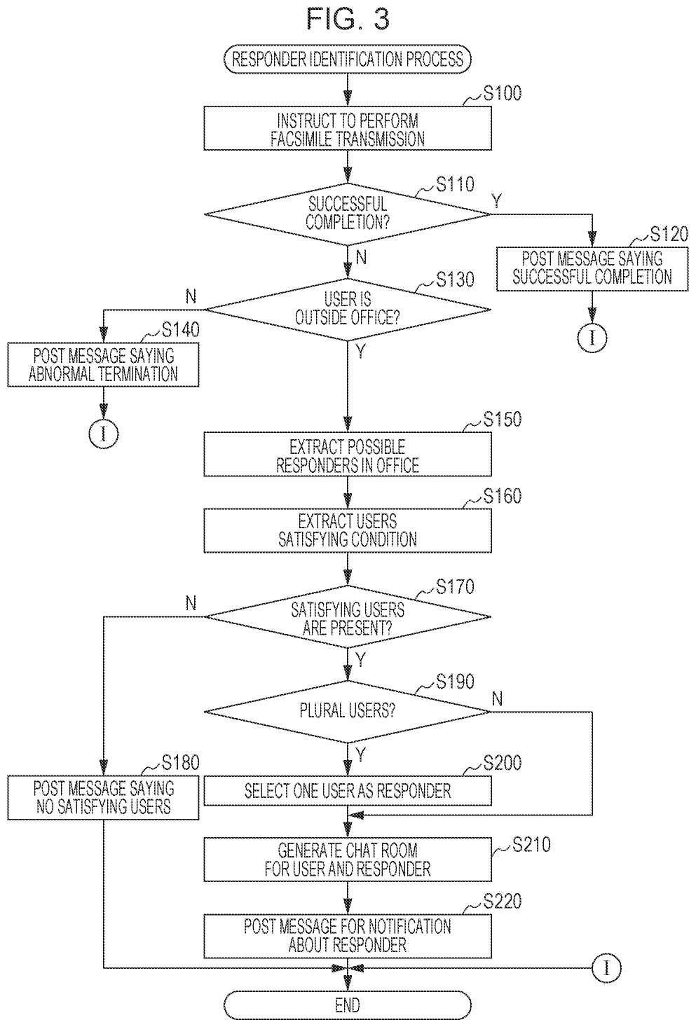

A process for identifying a responder in a case where a user uses the chat application in the PC 1 outside the office to instruct the multifunction machine 22 installed in the office to perform facsimile transmission and where an error occurs will be described with reference to the flowchart illustrated in FIG. 3.

The user of the PC 1 starts the chat application, opens the chat room 31, and posts messages to the chat room 31 to thereby make conversations with project members. The conversation processor 251 saves the messages posted by the user in the conversation history information memory 254 to thereby keep a history of the conversations made by using the chat room.

The user of the PC 1 posts information that is to be used in facsimile transmission and that includes an address and a transmission target document, as a message to thereby give the multifunction machine 22 an instruction for facsimile transmission from outside the office.

The conversation processor 251 saves a message posted to the chat room 31 in the conversation history information memory 254 and performs natural language processing for the message to thereby interpret the content of the message. When the message from the user of the PC 1 is an instruction for facsimile transmission given to the multifunction machine 22, the device operation controller 2531 instructs the multifunction machine 22 to perform facsimile transmission (step 100). Note that an instruction needs to be given in a manner the same as an existing manner. The message may be interpreted by the controller 253.

The multifunction machine 22 executes a facsimile transmission process in response to the instruction from the device operation controller 2531. The multifunction machine 22 returns the result of execution of the process to the device operation controller 2531.

If the result of execution transmitted from the multifunction machine 22 indicates successful completion of the facsimile transmission (Y in step 110), the controller 253 causes the conversation processor 251 to post to the chat room 31 a message saying that the facsimile transmission is successfully completed (step 120). Accordingly, the user of the PC 1 can know that the facsimile transmission is successful. If the result of execution transmitted from the multifunction machine 22 indicates not successful completion but abnormal termination of the facsimile transmission (N in step 110), determination as to whether the facsimile transmission is based on an instruction from inside the office or an instruction from outside the office is performed. This determination can be performed by analyzing, for example, address information or the like of the PC that has given the instruction. If the user who has given the instruction is in the office (N in step 130), the controller 253 causes the conversation processor 251 to post to the chat room 31 a message saying that the facsimile transmission is abnormally terminated (step 140). Accordingly, the user who is in the office refers to, for example, an error message included in the message and can respond to the error. Although the error can include a case of non-response where the result of execution is not returned from the multifunction machine 22 after the elapse of a predetermined time since the instruction for execution, the user who is in the office can, for example, move to the place where the multifunction machine 22 is installed and respond to the error.

If the user who has given the instruction for the facsimile transmission is outside the office (Y in step 130), even when the user refers to the error message and can identify the error, the user may be unable to respond to the error by themselves. This is all the more so in a case of a non-response error. Therefore, in a case where the result of execution from the multifunction machine 22 indicates abnormal termination or in a case of non-response, the event occurrence detector 2532 detects an error that has occurred in association with the instruction for the facsimile transmission process given by using chat.

In this case, the responder identification processor 252 refers to the schedule information and the conversation history information and extracts users who are in the office as possible responders (step 150). First of all, it is assumed that possible responders are users who are in the office and who can check display on the operation panel of the multifunction machine 22 or who can perform some operations on the multifunction machine 22. Therefore, the responder identification processor 252 refers to the schedule information and identifies users who are currently in the office.

As described above, some users may fix a schedule through conversations made by using chat but might not register the fixed schedule in the schedule management system 24 at the present time. In contrast, some users may have a schedule registered in the schedule information and canceled later and might not delete the schedule from the schedule information at the present time. Accordingly, the latest schedule might not be reflected in the schedule information. That is, it can be supposed that what can be known from the schedule information includes only scheduled-to-be-present persons who are scheduled to be in the office.

Therefore, the responder identification processor 252 in this exemplary embodiment targets and analyzes the schedules of users by using not only the schedule information managed by the schedule management system 24 but also the history of conversations made by using chat, specifically, messages related to a schedule not set in the schedule information, to thereby enable extraction of users, among scheduled-to-be-present person, who can be inferred to be present in the office at the present time with more certainty, as being-present persons.

Here, users who are in the office are extracted because they are likely to be able to respond to the occurrence of the facsimile transmission error. Although the assumption is that users are in the office, the locations of users to be extracted may be further narrowed down from places in the office. That is, in this exemplary embodiment, a condition for further narrowing down, in other words, a suitable-to-respond condition, that defines suitability for responding to the facsimile transmission error is set in advance, and users who satisfies this suitable-to-respond condition are extracted from among the being-present persons as users who are suitable for responding to the facsimile transmission error, that is, responders to the facsimile transmission error (step 160).

For example, the place where the multifunction machine 22 is installed can be identified from, for example, management information of devices managed in a memory not illustrated. The locations of users who are in the office can be identified from the schedule information and the conversation history information. When a user who is on the first floor is requested to respond to an error that has occurred in the multifunction machine 22 installed on the tenth floor, the requested user may feel uncomfortable about the request. Therefore, in this exemplary embodiment, as the suitable-to-respond condition, a condition for limiting the locations of users who are in the office is set. For example, places where possible responders are present are narrowed down to some extent to, for example, the floor or the room on or in which the multifunction machine 22 is installed to thereby identify a responder to the facsimile transmission error. For example, the distance from the multifunction machine 22 may be used. In this case, a threshold for the distance needs to be set in advance in order to identify a responder.

If one user is extracted as a result of narrowing down (N in step 190), the user can be identified as a responder to the facsimile transmission error. On the other hand, if plural users are extracted as a result of narrowing down (Y in step 190), the plural users need to be narrowed down to one responder to the facsimile transmission error (step 200). For example, a user whose desk is nearest to the multifunction machine 22 or a user who is listed first in the list of possible responders may be identified. Alternatively, a suitable-to-respond condition in an exemplary embodiment described below may be used.

When one responder is identified by any of the above-described methods, the chat system 25 generates a chat room 32 for making conversations between a requester and the responder (step 210). The chat system 25 sends to the user of the PC 1 posting to the chat room 31, a message saying that a request to respond to the facsimile transmission error is to be made to the responder by using the generated chat room 32 (step 220).

The user of the PC 1 refers to the message posted to the chat room 31 and posts to the chat room 32 a message for a request to respond to the facsimile transmission error. At this time point, the user of the PC 1 becomes the requester requesting a response to the error. The chat system 25 makes a request to respond to the error to the responder, in response to the message posted to the chat room 32 by the requester. In the following description, the user of the PC 1 may be referred to as “requester” even before a request to respond to the error is made.

When, for example, a notification from the chat system 25 is displayed on a PC 21b, the responder knows selection as a responder and generation of the chat room 32 for the responder and the requester. Accordingly, the responder responds at the request.

In this exemplary embodiment, when a user outside the office uses the multifunction machine 22 installed in the office and an event, that is, a facsimile transmission error in the above-described example, caused by the use occurs, a responder who responds to the facsimile transmission error is selected with reference to the locations of users in the office. When a request to respond to the facsimile transmission error is made, the responder may refuse the request, as a matter of course; however, in this exemplary embodiment, by taking into consideration the locations of users in the office, such as the positional relationships with the multifunction machine 22, a possible responder who is in the vicinity of the multifunction machine 22 in which the error has occurred, in other words, a possible responder whose amount of movement for responding to the facsimile transmission error is relatively small, is selected as a responder. Accordingly, the probability that a request to respond to the facsimile transmission error is refused is low.

Note that in this exemplary embodiment, one responder is selected by narrowing down, and the requester is given a notification about the responder; however, plural persons, such as top n (n is a positive integer) persons, may be presented to the requester as possible responders to have the requester last select one responder. The same applies to the following exemplary embodiments.

### Exemplary Embodiment 2

In Exemplary Embodiment 1 described above, a responder to a facsimile transmission error is identified at the time point when the occurrence of the facsimile transmission error is confirmed, by taking into consideration the locations of possible responders. That is, in Exemplary Embodiment 1 described above, the occurrence detection time point of the facsimile transmission error (the “present time” described above) is regarded as a time point when the error is to be responded, and the schedules of users who are in the office at the present time are referred to. However, responding to the facsimile transmission error may take time.

In this exemplary embodiment, a responder to an error is identified by taking into consideration the degrees of busyness of possible responders. That is, in this exemplary embodiment, the degree of busyness is set as the suitable-to-respond condition. The “degree of busyness” of each possible responder is estimated with reference to the setting state of their schedule at the time point when the facsimile transmission error is to be responded and in a predetermined period from the time point and with reference to the conversation history information. In other words, although the time point when the error is to be responded in Exemplary Embodiment 1 described above is the occurrence detection time point of the facsimile transmission error, the time point when the error is to be responded in this exemplary embodiment is within the predetermined period from the time point when the facsimile transmission error is to be responded, to thereby provide a time range.

The system configuration (FIG. 1) and the process for identifying a responder (FIG. 3) in this exemplary embodiment need to be similar to those in Exemplary Embodiment 1. In this exemplary embodiment, the specifics of the process in step 160 in the flowchart illustrated in FIG. 3 are different.

That is, after possible responders are extracted in step 150, the responder identification processor 252 refers to the setting states of the schedules of the possible responders at the time point when the facsimile transmission error is to be responded and in the predetermined period from the time point and identifies a user having no schedule as a responder. When it can be inferred from the conversation history information that a possible responder having no schedule set in the schedule information has a schedule after the time point when the facsimile transmission error is to be responded, this possible responder is not selected as a responder. Alternatively, it can be inferred that a possible responder who has no schedule registered in the schedule information but is frequently making conversations by using chat is busy with something, and therefore, this possible responder need not be selected as a responder.

The length of the predetermined period need not be set to a specific length and may be set to a fixed length or set in accordance with the occurring event. When performing step 160, the chat system 25 may refer to the requester for the length and set the length.

In this exemplary embodiment, a user who can be inferred to be busy from the schedule information, the use state of chat, and the conversation history information is not identified as a responder, and a responder who can respond to the request is selected with more certainty. In this exemplary embodiment, a threshold for the degree of busyness needs to be set in advance in order to identify a responder.

### Exemplary Embodiment 3

Usually, when a person requests someone to do something, such as a response to an error, the person feels more comfortable making a request to an acquaintance than to a stranger. Therefore, in this exemplary embodiment, a responder is identified by taking into consideration the degrees of familiarity between users (“possible responders” described above) in the office and the user (“requester” described above) of the PC 1. That is, in this exemplary embodiment, the degree of familiarity is set as the suitable-to-respond condition.

The system configuration (FIG. 1) and the process for identifying a responder (FIG. 3) in this exemplary embodiment need to be similar to those in Exemplary Embodiment 1. In this exemplary embodiment, the specifics of the process in step 160 in the flowchart illustrated in FIG. 3 are different.

That is, after possible responders are extracted in step 150, the responder identification processor 252 analyzes the conversation history information to thereby estimate the degrees of familiarity between the requester and the possible responders. Regarding each of the degrees of familiarity, for example, at least one of the number of conversations with the requester user or the number of conversations started by the requester user in a predetermined period in the conversation history information may be referred to. As the number of conversations is larger, the degree of familiarity is evaluated to be higher. When both the numbers of conversations are to be referred to, the degree of familiarity may be calculated by using a predetermined calculation formula in which each of the numbers of conversations are weighted. The predetermined period for which the number of conversations is counted need not be limited to a specific period. The distribution or the degree of dispersion of conversations in the predetermined period may be taken into consideration. For example, the degree of familiarity of a possible responder who makes conversations intermittently may be evaluated to be higher than a possible responder who makes conversations temporarily and intensively. Accordingly, the responder identification processor 252 identifies a possible responder having the highest degree of familiarity as a responder.

According to this exemplary embodiment, a user to whom the requester feels comfortable making a request to respond to an error is selected as a responder. In this exemplary embodiment, a threshold for the degree of familiarity needs to be set in advance in order to identify a responder.

### Exemplary Embodiment 4

When receiving a request to respond to an error, some users may accept the request and some users may refuse the request. The response attitude toward a request may depend on the user's current busyness or other conditions but can be considered to basically depend on their character, mentality, or the like. That is, a user who accepts a request basically tends to accept requests, and a user who refuses a request basically tends to refuse requests. Therefore, in this exemplary embodiment, a responder is identified by taking into consideration the response attitude toward an error taken in response to a request. That is, in this exemplary embodiment, the response attitude toward an event is set as the suitable-to-respond condition.

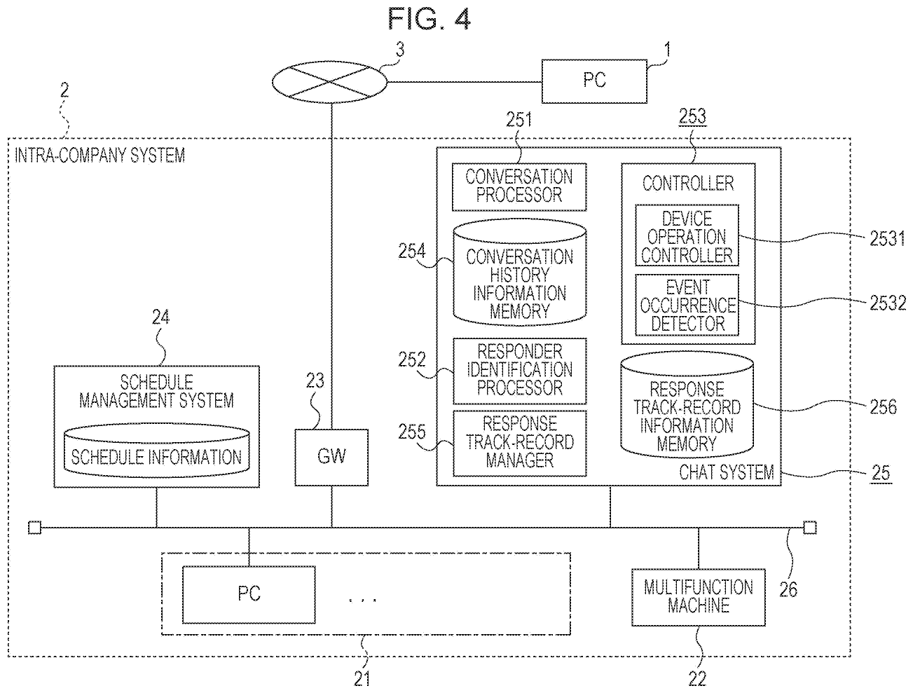

FIG. 4 is a diagram illustrating an overall configuration of a network system according to this exemplary embodiment. Configuration elements the same as those in FIG. 1 are assigned the same reference numerals, and descriptions thereof will be omitted. The network system in this exemplary embodiment has a configuration that includes the chat system 25 illustrated in FIG. 1 to which a response track-record manager 255 and a response track-record information memory 256 are added. As described above, some responders respond to a request from a requester and some responders do not. The response track-record manager 255 manages track records of such responses made by responders in response to requests. For this, when the requester makes a request to a responder to respond to an error, the response track-record manager 255 generates and records to the response track-record information memory 256 response track-record information regarding the track record of a response made by the responder in response to the request. The response track-record information includes request date-and-time information, information for identifying the requester and the responder, information indicating the content of the message and the details of request including the type of the occurring event, and the state of a response made by the responder in response to the request, that is, information with which whether the responder accepts or refuses the request can be known. The response track-record manager 255 is implemented by cooperative operations between the computer that forms the chat system 25 and a program that runs on the CPU included in the computer. The response track-record information memory 256 is implemented as the HDD included in the chat system 25. Alternatively, the RAM may be used or an external memory may be used via a network.

Now, operations in this exemplary embodiment will be described. In this exemplary embodiment, when an error occurs in a facsimile transmission process, the requester posts a message to the chat room 32 as described above to thereby make a request to a responder to respond to the error. In response to this request, the responder may or might not respond at the request. The response track-record manager 255 performs natural language processing for the message posted to the chat room 32 to thereby interpret the content of the message. The response track-record manager 255 determines whether the responder last accepts or refuses the request, and generates and registers to the response track-record information memory 256 response track-record information that includes the result of determination. The response track-record manager 255 repeats generation and registration of response track-record information each time an event occurs. Accordingly, track records of responses made by responders in response to requests from requesters are accumulated in the response track-record information memory 256.

Although a description of a process for identifying a responder when an error occurs will be given below, this process (FIG. 3) needs to be similar to that in Exemplary Embodiment 1. In this exemplary embodiment, the specifics of the process in step 160 in the flowchart illustrated in FIG. 3 are different.

That is, after possible responders are extracted in step 150, the responder identification processor 252 analyzes the response track-record information to thereby estimate the possible responders' response attitudes toward events. Regarding the response attitudes, for example, the number of times each possible responder accepts a request to respond to an error as a responder or the number of times each possible responder refuses such a request in a predetermined period in the response track-record information is referred to. The predetermined period for which the number of times making a response is accepted or the number of times making a response is refused is counted need not be limited to a specific period. Further, the tendency to accept making a response and the tendency to refuse making a response in the predetermined period, namely, for example, an increasing or decreasing tendency to accept and an increasing or decreasing tendency to refuse, may be taken into consideration. For example, the response attitude of a possible responder who often refused requests previously but has accepted requests recently may be evaluated to be good. The response attitude may be, for example, converted into a numerical form by calculating, for example, the ratio of the number of times acceptance is provided relative to the number of requests made in the predetermined period. The responder identification processor 252 identifies a possible responder having the best response attitude as a responder.

According to this exemplary embodiment, a user who is highly likely to accept a request made by a requester to respond to an error is selected as a responder. In this exemplary embodiment, a threshold for the response attitude needs to be set in advance in order to identify a responder.

Although a description on a facsimile transmission error has been given in the above-described exemplary embodiments as an example of an event that occurs in association with an instruction for executing a process given by using chat, the function to be used need not be limited to facsimile transmission. Further, the event need not be limited to an error. For example, the above-described exemplary embodiments are applicable to a case of, for example, assuming display on the operation panel of the multifunction machine 22 or lighting or blinking of an indicator during maintenance performed remotely by a remote operation to be the event and having a user in the office check the display or the like. In this case, for example, a user who is familiar with the multifunction machine 22 or the administrator of the multifunction machine 22 may be set as the suitable-to-respond condition.

The above-described exemplary embodiments assume that the location of the requester is a place outside the office, and a place other than the location of the requester is a place inside the office. However, regarding the location of the requester, a place inside and a place outside need not be defined as described above. For example, regarding the location of the requester, a place inside and a place outside may be defined on the basis of, for example, the floor on which the requester is present in a case of the same office or the room in which the requester is present in a case of the same floor.

Although each of the place, the degree of busyness, the degree of familiarity, and the response attitude has been described as an example of the suitable-to-respond condition in the above-described exemplary embodiments, these may be combined as appropriate or priority levels may be set for these to thereby set the suitable-to-respond condition.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
identify, for an event that occurs in association with an instruction for executing a process given by a user using a messenger application, the event occurring at a place other than a location of the user, a responder who is present at the place of occurrence of the event and who is able to respond to the event, with reference to schedule information of possible responders and history information of conversations made by the possible responders using the messenger application; and
make a request to the responder to respond to the event, by using the messenger application.

2. The information processing apparatus according to claim 1, wherein:
the processor is configured to:
extract from among the possible responders, scheduled-to-be-present persons who are present at the place of occurrence at a time point when the event is to be responded, by analyzing the schedule information;
extract as a being-present person from among the scheduled-to-be-present persons, a scheduled-to-be-present person who is inferred to be actually present at the place of occurrence at the time point when the event is to be responded as a result of analyzing the history information of conversations made by the scheduled-to-be-present persons using the messenger application; and
identify the extracted being-present person as the responder.

3. The information processing apparatus according to claim 2, wherein the processor is configured to identify the responder by targeting and analyzing a message included in the history information and related to a change in a schedule that has been set in the schedule information and a message included in the history information and related to a schedule that is not set in the schedule information.

4. The information processing apparatus according to claim 1, wherein the processor is configured to identify the responder by taking into consideration degrees of busyness of the possible responders at the time point when the event is to be responded and after the time point, the degrees of busyness being estimated by analyzing the schedule information and the history information.

5. The information processing apparatus according to claim 4, wherein the processor is configured to estimate the degrees of busyness of the possible responders with reference to setting states of schedules in a predetermined period from the time point when the event is to be responded, the schedules being included in the schedule information, and with reference to content of conversations made in a predetermined period from an occurrence detection time point of the event, the conversations being included in the history information.

6. The information processing apparatus according to claim 1, wherein the processor is configured to identify the responder by taking into consideration degrees of familiarity of the possible responders with the user, the degrees of familiarity being estimated by analyzing the history information.

7. The information processing apparatus according to claim 6, wherein the processor is configured to estimate each of the degrees of familiarity of the possible responders with the user with reference to at least one of the number of conversations with the user or the number of conversations started by the user, the conversations being included in the history information.

8. The information processing apparatus according to claim 1, wherein:
the processor is configured to:
record response track-record information regarding track records of responses made by responders in response to requests; and
identify the responder by taking into consideration a response attitude toward the event to be taken in response to the request, the response attitude being estimated from the response track-record information.

9. The information processing apparatus according to claim 8, wherein the processor is configured to estimate response attitudes of the possible responders toward the event with reference to the number of times each of the possible responders accepts a request or the number of times each of the possible responders refuses a request.

10. A non-transitory computer readable medium storing a program causing a computer to execute a process comprising:
identifying, for an event that occurs in association with an instruction for executing a process given by a user using a messenger application, the event occurring at a place other than a location of the user, a responder who is present at the place of occurrence of the event and who is able to respond to the event, with reference to schedule information of possible responders and history information of conversations made by the possible responders using the messenger application; and
making a request to the responder to respond to the event, by using the messenger application.

11. An information processing method comprising:
identifying, for an event that occurs in association with an instruction for executing a process given by a user using a messenger application, the event occurring at a place other than a location of the user, a responder who is present at the place of occurrence of the event and who is able to respond to the event, with reference to schedule information of possible responders and history information of conversations made by the possible responders using the messenger application; and
making a request to the responder to respond to the event, by using the messenger application.
